(19) United States
(12) Patent Application Publication
(10) Pub. No.: US 2025/0168451 A1
(43) Pub. Date: May 22, 2025

(54) METHOD, APPARATUS, TERMINAL DEVICE, SERVER AND STORAGE MEDIUM FOR PLAYBACK CONTROL

(71) Applicant: Beijing Zitiao Network Technology Co., Ltd., Beijing (CN)

(72) Inventor: Wenyu Wang, Beijing (CN)

(21) Appl. No.: 18/841,640

(22) PCT Filed: Feb. 21, 2023
(86) PCT No.: PCT/CN2023/077505

§ 371 Date: Aug. 26, 2024

(30) Foreign Application Priority Data
Feb. 25, 2022 (CN) 202210179904.X

(51) Int. Cl. H04N 21/458; H04N 21/437; H04N 21/478; H04N 21/81

(52) U.S. Cl. CPC H04N 21/458; H04N 21/437; H04N 21/478; H04N 21/812

(57) ABSTRACT

The disclosure provides a method, apparatus, terminal device, server, electronic device, computer-readable storage medium, a computer program product and a computer program for playback control. The method for playback control includes: obtaining a playback duration of a first playback content in a playback scene; and in response the playback duration satisfying a target condition, sending first indication information to a first server, wherein the first indication information indicates to change a virtual resource in account information of a user, and the target condition resource corresponds to the playback scene of the first playback content.

### CROSS REFERENCE

This disclosure claims priority to Chinese Patent Application No. 202210179904.X, filed to the Chinese Patent Office on Feb. 25, 2022, and entitled “METHOD, APPARATUS, TERMINAL DEVICE, SERVER AND STORAGE MEDIUM FOR PLAYBACK CONTROL”, which is hereby incorporated by reference in its entirety.

### FIELD

The present disclosure relates to the field of information interaction technologies, and in particular, to a method, apparatus, terminal device, server, electronic device, computer readable storage medium, computer program product and a computer program for playback control.

### BACKGROUND

With the development of network technology, in order to encourage a user to use applications more deeply, various different methods are used currently in various applications to improve the duration of using applications by the user. Virtual resources may be provided to the user based on the usage duration of the user.

### SUMMARY

The present disclosure provides a method, apparatus, terminal device, server, electronic device, computer-readable storage medium, computer program product and computer program for playback control.

In a first aspect, embodiments of the present disclosure provide method for playback control, applied at a client, including:
obtaining a playback duration of a first playback content in a playback scene; and
in response the playback duration satisfying a change condition of a virtual resource, sending first indication information to a first server, wherein the first indication information is used to indicate to change the virtual resource in account information of a user, and the change condition of the virtual resource corresponds to the playback scene of the first playback content.

In a second aspect, embodiments of the present disclosure provide a method for playback control, applied at a first server, including:
receiving a first request sent by a client, wherein the first request is used to request to obtain a first playback content played in a playback scene and the first request includes an identifier of the playback scene;
determining, based on the identifier of the playback scene, a change condition of a virtual resource in account information of a user corresponding to the first playback content to be played; and
sending first feedback to the client, wherein the first feedback includes the first playback content and the change condition of the virtual resource.

In a third aspect, embodiments of the present disclosure provide method for playback control, applied at a second server, including:
receiving a second request sent by a first server, wherein the second request is used to request to match a first playback content corresponding to a user and the second request includes an identifier of the user;
determining, based on the identifier of the user, the first playback content corresponding to the user; and
sending second feedback to the first server, wherein the second feedback includes the first playback content.

In a fourth aspect, embodiments of the present disclosure provide method for playback control, applied at a third server, including:
receiving resource value information of a first playback content sent by a first server;
determining a change parameter of a virtual resource in account information of a user based on the resource value information of the first playback content; and
sending the change parameter of the virtual resource to the first server.

In a fifth aspect, embodiments of the present disclosure provide an apparatus for playback control. The apparatus includes:
an obtaining module configured to obtain a playback duration of a first playback content in a playback scene; and
a sending module configured to, in response the playback duration satisfying a change condition of a virtual resource, send first indication information to a first server, wherein the first indication information is used to indicate to change the virtual resource in account information of a user, and the change condition of the virtual resource corresponds to the playback scene of the first playback content.

In a sixth aspect, embodiments of the present disclosure provide an apparatus for playback control. The apparatus includes:
a receiving module configured to receive a first request sent by a client, wherein the first request is used to request to obtain a first playback content played in a playback scene and the first request includes an identifier of the playback scene;
a processing module configured to determine, based on the identifier of the playback scene, a change condition of a virtual resource in account information of a user corresponding to the first playback content to be played; and
a sending module configured to send first feedback to the client, wherein the first feedback includes the first playback content and the change condition of the virtual resource.

In a seventh aspect, embodiments of the present disclosure provide an apparatus for playback control. The apparatus includes:
a receiving module configured to receive a second request sent by a first server, wherein the second request is used to request to match a first playback content corresponding to a user and the second request includes an identifier of the user;
a processing module configured to determine, based on the identifier of the user, the first playback content corresponding to the user; and
a sending module configured to send second feedback to the first server, wherein the second feedback information includes the first playback content.

In an eighth aspect, embodiments of the present disclosure provide an apparatus for playback control. The apparatus includes:
a receiving module configured to receive resource value information of a first playback content sent by a first server;
a processing module configured to determine a change parameter of a virtual resource in account information of a user based on the resource value information of the first playback content; and
a sending module configured to send the change parameter of the virtual resource to the first server.

In a ninth aspect, embodiments of the present disclosure provide a terminal device, including:
a processor; and a memory configured to store a computer program;
wherein the processor is configured to, by executing the computer program, implement the method for playback control of the design of the first aspect.

In a tenth aspect, embodiments of the present disclosure provide a server, including:
a processor; and a memory configured to store a computer program;
wherein the processor is configured to, by executing the computer program, implement the method for playback control of various possible designs of the first aspect, the second aspect, the third aspect or the fourth aspect.

In an eleventh aspect, embodiments of the present disclosure provide an electronic device, including:
a processor; and a memory configured to store a computer program;
wherein the processor is configured to, by executing the computer program, implement the method for playback control of the design of the first aspect.

In a twelfth aspect, embodiments of the present disclosure provide an electronic device, including:
a processor; and a memory configured to store a computer program;
wherein the processor is configured to, by executing the computer program, implement the method for playback control of various possible designs of the second aspect, the third aspect or the fourth aspect.

In a thirteenth aspect, embodiments of the present disclosure provide a computer-readable storage medium. The computer readable storage has a computer program stored thereon, the computer program, when executed by a processor, implements the method for playback control of the design of the first aspect.

In a fourteenth aspect, embodiments of the present disclosure provide a computer readable storage medium. The computer readable storage has a computer program stored thereon, the computer program, when executed by a processor, implements the method for playback control of various possible designs of the second aspect, the third aspect and the fourth aspect.

In a fifteenth aspect, embodiments of the present disclosure provide a computer program product, including a computer program which, when executed by a processor, implements the method for playback control of the design of the first aspect.

In a sixteenth aspect, embodiments of the present disclosure provide a computer program product, including a computer program which, when executed by a processor, implements the method for playback control of various possible designs of the second aspect, the third aspect and the fourth aspect.

In a seventeenth aspect, embodiments of the present disclosure provide a computer program, wherein the computer program is configured to implement the method for playback control of the design of the first aspect.

In an eighteenth aspect, embodiments of the present disclosure provide a computer program, wherein the computer program is configured to implement the method for playback control of the design of various possible designs of the second aspect, the third aspect and the fourth aspect.

### BRIEF DESCRIPTION OF THE DRAWINGS

To more clearly illustrate the technical solutions in the embodiments of the present disclosure or the relevant art, a brief introduction will be made below to the drawings that need to be used in the description of the embodiments or the relevant art. Obviously, the drawings in the following description are some embodiments of the present disclosure and those of ordinary skill in the art may also obtain other drawings based on these drawings without creative efforts.

FIG. 1 is a schematic flowchart of a method for playback control provided by embodiments of the present disclosure.

FIG. 2 is a schematic diagram of a page of a playback scene provided by embodiments of the present disclosure.

FIG. 3 is a signaling interaction diagram of a method for playback control provided by embodiments of the present disclosure.

FIG. 4 is a signaling interaction diagram of another method for playback control provided by embodiments of the present disclosure.

FIG. 5 is a schematic structural diagram of an apparatus for playback control provided by embodiments of the present disclosure.

FIG. 6 is a schematic structural diagram of another apparatus for playback control provided by embodiments of the present disclosure.

FIG. 7 is a schematic structural diagram of yet another apparatus for playback control provided by embodiments of the present disclosure.

FIG. 8 is a schematic structural diagram of yet another apparatus for playback control provided by embodiments of the present disclosure.

FIG. 9 is a schematic structural diagram of an electronic device provided by embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are merely examples and are not intended to limit the scope of the present disclosure.

It should be understood that the steps recited in the method implementations of the present disclosure may be executed in different orders, and/or executed in parallel. Furthermore, method implementations may include additional steps and/or omit the performance of illustrated steps. The scope of the present disclosure is not limited in this respect.

The term “comprise” and variations thereof, as used herein, is inclusive, that is, “including but not limited to”. The term “based on” is “based at least in part on”. The term “an embodiment” means “at least one embodiment”; the term “another embodiment” means “at least one further embodiment”; The term “some embodiments” means “at least some embodiments”. Relevant definitions of other terms will be given in the following description.

It should be noted that the modifications of “a” and “a plurality of” mentioned in the present disclosure are illustrative rather than restrictive, and those skilled in the art should understand that they should be understood as ‘one or more’ unless the context clearly indicates otherwise.

In the relevant art, when the duration of a specific behavior, such as a user using an application to watch a video or read news, satisfies a change condition of a virtual resource, the predetermined amount of virtual resources may be sent to the user. However, in order to improve the user experience of an application, the flexibility of changing virtual resources needs to be further improved.

With regard to the above technical problem, the present disclosure aims to set different change conditions of virtual resources for different playback scenes, and only when a playback content satisfies a change condition of a virtual resource corresponding to the playback scene, the virtual resource in an account of a user is changed. In this way, different change conditions of the virtual resource may be adopted according to different playback scenes, thereby improving the flexibility of changing the virtual resource and improving the user experience.

The application scenes of the method for playback control provided by the present disclosure will be described below.

In an application scene of the method for playback control, the method for playback control provided by embodiments of the present disclosure may be applied to a scene of a video application. When a user uses the video application, different timers may be set for a splash advertisement scene and a video playback scene. When the user watches a playback content (a video, an image, a text, etc.) in the splash advertising scene, if a timer corresponding to the splash advertising scene times out, virtual resources may be provided to the user. When a user watches a playback content (a video, an image, a text, etc.) in a video playback scene, if a timer corresponding to the video playback scene times out, virtual resources may also be provided to the user.

In another application scene of the method for playback control, the method for playback control provided by embodiments of the present disclosure may be applied to a scene of an information application. When a user uses the information application, different timers may be set for an information reading scene and an on-screen advertisement scene. When the user reads the information content in the information reading scene, if the timer corresponding to the information reading scene times out, virtual resources may be provided to the user. When the user watches a playback content in the splash advertising scene, if a timer corresponding to the splash advertising scene times out, virtual resources may also be provided to the user.

It should be noted that the above two application scenes do not constitute a limitation on the present disclosure, and the method for playback control provided by the present disclosure may be applied to any virtual resource obtaining scene.

It can be understood that the above method for playback control may be implemented by an apparatus for playback control provided by embodiments of the present disclosure, and the apparatus for playback control may be part or all of a certain device, such as a client or a server.

The technical solutions of the embodiments of the present disclosure will be described in detail below with reference to specific embodiments. The following specific embodiments may be combined with each other, and the same or similar concepts or processes may not be repeated in some embodiments.

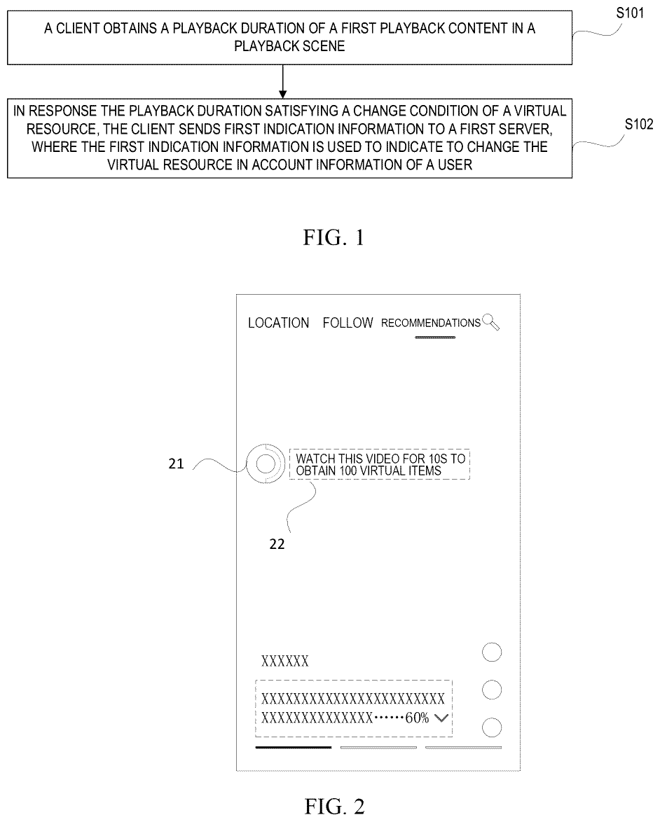

FIG. 1 is a schematic flowchart of a method for playback control provided by embodiments of the present disclosure. As shown in FIG. 1, the method for playback control provided by embodiments of the present disclosure includes:

At step 101, a client obtains a playback duration of a first playback content in a playback scene.

It should be understood that embodiments of the present disclosure do not limit the first playback content, and the first playback content may be a video and/or a text. In some embodiments, the first playback content may also be set to a particular type of playback content, such as an advertising video and/or an advertising text.

It should be understood that embodiments of the present disclosure also do not limit the type of the playback scene which may be specifically set according to the type of the application. In an example, if the application is a video application, the playback scene may include a splash advertisement scene, a video playback scene, etc.

The playback duration involved in the present disclosure will be described below.

In some embodiments, the playback duration may be a continuous playback duration of the first playback content in the playback scene. Correspondingly, the timer corresponding to the first playback content performs timing in a mode of resetting the timing, the timer for the resetting timing resets upon a switch from the first playback content to a second playback content, and upon a switch from the second playback content back to the first playback content, the timer restarts from zero.

In an example, the first playback content is switched to the second playback content when the playback duration measured by the timer is 5 seconds, then the timer restarts from 0 seconds when the second playback content is switched back to the first playback content.

In some embodiments, the playback duration may be an accumulated playback duration of the first playback content in the playback scene. Correspondingly, the timer corresponding to the first playback content performs timing in a mode of accumulating the timing, the timer for the accumulating timing suspends counting upon a switch from the first playback content to a second playback content, and upon a switch from the second playback content back to the first playback content, the timer resumes counting from a time when the counting is suspended.

In an example, the first playback content is switched to the second playback content when the playback duration measured by the timer is 5 seconds, and the timer resumes counting from 5 seconds when the second playback content is switched back to the first playback content.

It should be understood that the above second play content is different from the first play content, or the type of the second play content is different from the type of the first play content. In an example, if the first playback content is video A, the second play content may be video B, video C, and the like that are different from the video A. In an example, if the first playback content is an advertising video, the second play content may be any other type of video that is not an advertising video.

In some embodiments, a timer is displayed on a playback page corresponding to the playback scene, and the playback duration of the first playback content may be counted by the timer.

It should be understood that embodiments of the present disclosure do not limit the display position and display manner of the timer. In an example, FIG. 2 is a schematic diagram of a page of a playback scene provided by embodiments of the present disclosure. As shown in FIG. 2, a first playback content is played on the page, a timer 21 for counting a playback duration of the first playback content is displayed on the left side of the page, and the timer 21 displays the playback duration of the first playback content in the playback scene through an arc-shaped progress bar.

At step 102, in response the playback duration satisfying a change condition of a virtual resource, the client sends first indication information to a first server, where the first indication information is used to indicate to change the virtual resource in account information of a user.

Embodiments of the present disclosure do not limit the type of virtual resources which may be virtual item resources, emoticon resources, card resources and the like, or permissions to use specific functions of applications, etc.

It should be understood that embodiments of the present disclosure do not limit the change condition of the virtual resources. In some embodiments, the change condition of the virtual resource includes a target playback duration of the first playback content. Accordingly, a maximum counting duration of the timer is the target playback duration. In other embodiments, the change condition of the virtual resource may further include that the user triggers the space of the first playback content in the playback scene, thereby jumping to a corresponding page.

In an example, the change condition of the virtual resource is the target playback duration of the first playback content. If the target playback duration of the first playback content is 10 seconds, the change condition of the virtual resource is satisfied after the user plays the first playback content over 10 seconds, so that the client sends the first indication information used for changing the virtual resource to the first server.

It should be noted that in the embodiments of the present disclosure, the change condition of the virtual resource may correspond to the playback scene of the first playback content.

In an example, if the playback scene is a splash advertisement scene, the change condition of the virtual resource may be the target playback duration corresponding to the splash advertisement scene being 10 seconds. If the playback scene is the video playback scene, the change condition of the virtual resource may be the target playback duration corresponding to the video playback scene being 5 seconds.

It should be understood that embodiments of the present disclosure do not limit how to change the virtual resource in the account information of the user. In some embodiments, changing the virtual resource may include increasing a numerical value of the virtual resource, adding a new virtual resource, or changing a state of the virtual resource.

In an example, if changing the virtual resource is increasing a numerical value of the virtual resource, after receiving the first indication information sent by the client, the server may increase the numerical value of the virtual resource in the account information of the user. For example, the number of virtual items is changed from 5 to 10. In an example, if changing the virtual resource is adding a new virtual resource, after receiving the first instruction information sent by the client, the server may add a new virtual resources to the user account information. For example, a new virtual props is added. In an example, if changing the virtual resource is changing a state of the virtual resource, after receiving first instruction information sent by the client, the server may activate a virtual resource that is in an inactive state. For example, the collected card A is activated.

It should be noted that if changing the virtual resource is increasing a numerical value of the virtual resource, a change parameter of the virtual resource may also correspond to the playback scene or the first playback content.

In an example, the first indication information triggered in the splash advertisement scene may indicate the numerical value of the virtual resource plus 10, and the first indication information triggered in the video playback scene may indicate the numerical value of a virtual resource plus 5

In an example, because a playback resource value of video A is higher than that of video B, the first indication information triggered when video A is played may indicate a numerical value of virtual resources plus 10, or the first indication information triggered when video A is played may indicate a numerical value of virtual resources plus 5.

In some embodiments, if changing the virtual resource is increasing a numerical value of the virtual resource, the first feedback sent by the first server to the client may further include a change parameter of the virtual resource, where the change parameter of the virtual resource is used to indicate the value of increasing the virtual resource. Correspondingly, second indication information may further be displayed on the playback page corresponding to the playback scene, where the second indication information is used to indicate the change parameter of the virtual resource.

In an example, continuing to refer to FIG. 2, an information frame 22 may be set on the right side of the timer shown in FIG. 2, and the second indication information may be display in the information frame, to indicate the change parameter of the virtual resource, thereby reminding the virtual resource that may be obtained after the change condition of the virtual resource is satisfied.

In the method for playback control provided by embodiments of the present disclosure, the playback duration of the first playback content in the playback scene is obtained. If the playback duration satisfies the change condition of the virtual resource, the first indication information is sent to the first server, and the first indication information is used to indicate to change the virtual resource in the account information of the user, and the change condition of the virtual resource corresponds to the playback scene of the first playback content. In this way, different change conditions of the virtual resource may be adopted according to different playback scenes, thereby improving the flexibility of changing the virtual resource and improving the user experience.

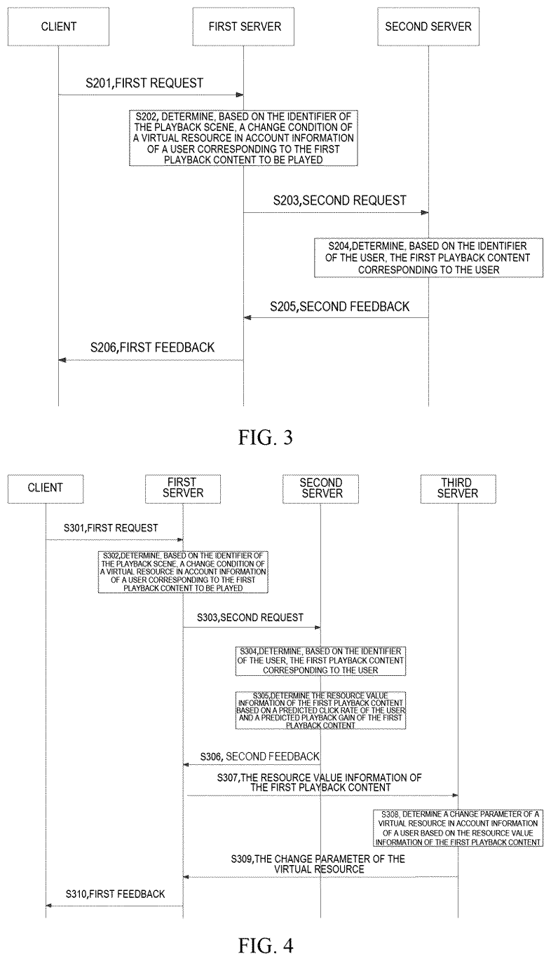

On the basis of the foregoing embodiments, how the client determines the change condition of the virtual resource will be described below. FIG. 3 is a signaling interaction diagram of a method for playback control provided by embodiments of the present disclosure. As shown in FIG. 3, the method for playback control provided by embodiments of the present disclosure includes:

At step 201, the client sends a first request to the first server, where the first request is used to request to obtain the first playback content in the playback scene.

The first request includes an identifier of the playback scene and an identifier of the user.

In the present disclosure, the client may send the first request to the first server to inform the first server of the playback scene where the client is currently located in real time, and request to obtain the first playback content played in the playback scene.

It should be understood that the first playback content may correspond to the playback scene, or may also correspond to the user, which is not limited in the present disclosure.

In an example, if user A operates the client to enter the splash advertisement scene, the client sends the first request to the first server, where the first request carries an identifier of the user A and an identifier of the splash advertisement scene to obtain the first playback content corresponding to the user A or corresponding to the splash advertisement scene.

At step 202, the first server determines, based on the identifier of the playback scene, a change condition of a virtual resource in account information of a user corresponding to the first playback content to be played.

In this step, after receiving the first request sent by the client, the first server may obtain the identifier of the playback scene from the first request to determine the changing condition of the virtual resource corresponding to the first playback content to be played based on the identifier of the playback scene.

It should be understood that embodiments of the present disclosure do not limit how the first server determines the change condition of the virtual resource based on the identifier of the playback scene. In some embodiments, identifiers of different playback scenes may correspond to change conditions of different types of virtual resources. In an example, a change condition of a virtual resource corresponding to an identifier of a playback scene A may be that a user triggers a control in the virtual scene. A change condition of a virtual resources corresponding to an identifier of a playback scene B may be that the playback duration reaches a target playback duration.

In other embodiments, identifiers of different playback scenes may also correspond to different values of a change condition of a virtual resource of a same type. In an example, the change condition of the virtual resource corresponding to the identifier of the playback scene A and the identifier of the playback scene B may be that the playback duration reaches the target playback duration. The target playback duration corresponding to the playback scene A may be 10 seconds, and the target playback duration corresponding to the playback scene B may be 5 seconds.

At step 203, the first server sends second request to a second server, where the second request is used to request to match the first play content corresponding to the user and the second request includes an identifier of the user.

At step 204, the second server determines, based on the identifier of the user, the first playback content corresponding to the user.

In this step, when receiving the second request sent by the first server, the second server may perform retrieval in a content database based on the identifier of the user in the second request, thereby determining the first playback content corresponding to the user.

It should be understood that embodiments of the present disclosure do not limit how the second server retrieves the first playback content corresponding to the user in the content database.

At step 205, the second server sends second feedback to the first server, where the second feedback includes the first playback content.

In some embodiments, the second feedback information can further include duration information of the first played content and resource value information of the second played content.

The duration of the first playback content may be recorded in the content database, and after retrieving the first playback content matching the user, the second server may directly obtain the first playback content and the duration of the first playback content from the content database.

It should be understood that embodiments of the present disclosure do not limit how to determine the resource value information of the first playback content. In some embodiments, the second server may determine the resource value information of the first playback content based on a predicted click rate of the user and a predicted playback gain of the first playback content.

The predicted click rate of the user may be predicted based on a historical click rate of the user on playback content of the same type as the first playback content. Correspondingly, the predicted playback gain of the first playback content may also be predicted based on the historical gain of the playback content of the same type.

At step 206, the first server sends first feedback to the client, where the first feedback includes the first playback content and the change condition of the virtual resource.

On the basis of the foregoing embodiments, how the client determines the change parameters of the virtual resource is explained below. FIG. 4 is a signaling interaction diagram of another method for playback control provided by embodiments of the present disclosure. As shown in FIG. 4, the method for playback control provided by embodiments of the present disclosure includes:

At step 301, the client sends first request to the first server, where the first request is used to request to obtain the first playback content played in the playback scene.

The first request includes an identifier of the playback scene and an identifier of the user.

At step 302, the first server determines, based on the identifier of the playback scene, a change condition of a virtual resource in account information of a user corresponding to the first playback content to be played.

At step 303, the first server sends second request to a second server, where the second request is used to request to match the first play content corresponding to the user and the second request includes an identifier of the user.

At step 304, the second server determines, based on the identifier of the user, the first playback content corresponding to the user.

At step 305: the second server determines the resource value information of the first playback content based on a predicted click rate of the user and a predicted playback gain of the first playback content.

At step 306: the second server sends second feedback to the first server, where the second feedback includes the first playback content and the resource value information of the first playback content.

The technical terms, technical effects, technical features and optional implementations of S301-S306 may be understood with reference to S201-S205 shown in FIG. 3, and repeated contents will not be elaborated herein.

At step 307: the first server sends the resource value information of the first playback content to a third server.

At step 308: the third server determines a change parameter of a virtual resource in account information of a user based on the resource value information of the first playback content.

It should be understood that the present disclosure does not limit how to determine the change parameter of the virtual resource in the account information of the user based on the resource value information of the first playback content. In some embodiments, the third server may determine the change parameter of the virtual resource based on the resource value information of the first playback content and a predetermined playback conversion parameter.

In an example, if the predetermined playback conversion parameter is 5 and the resource value of the first playback content is T, the change parameter of the virtual resource may be determined based on a ratio of T to 5.

At step 309, the third server sends the change parameter of the virtual resource to the first server.

At step 310, the first server sends first feedback to the client, where the first feedback includes the first playback content and the change condition of the virtual resource.

In some embodiments, the first server may further generate second indication information based on the change parameter of the virtual resource and the change condition of the virtual resource, thereby adding the second indication information to the first feedback.

In an example, if the change condition of the virtual resource is to play the first playback content for 10 seconds and the changing parameter of the virtual resource is five virtual items, the second indication information “five virtual items may be obtained by playing the first playback content for 10 seconds” may be generated.

In the method for playback control provided by embodiments of the present disclosure, the playback duration of the first playback content in the playback scene is obtained. If the playback duration satisfies the change condition of the virtual resource, the first indication information is sent to the first server, and the first indication information is used to indicate to change the virtual resource in the account information of the user, and the change condition of the virtual resource corresponds to the playback scene of the first playback content. In this way, different change conditions of the virtual resource may be adopted according to different playback scenes, thereby improving the flexibility of changing the virtual resource and improving the user experience.

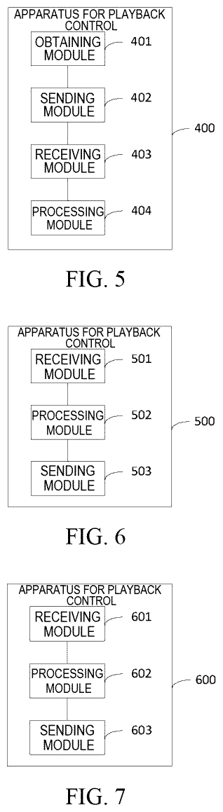

FIG. 5 is a schematic structural diagram of an apparatus for playback control provided by embodiments of the present disclosure. The apparatus for playback control is configured to perform the method for playback control on the client side. As shown in FIG. 5, the apparatus for playback control 400 provided by embodiments of the present disclosure includes:
an obtaining module 401 configured to obtain a playback duration of a first playback content in a playback scene; and
a sending module 402 configured to, in response the playback duration satisfying a change condition of a virtual resource, send first indication information to a first server, wherein the first indication information is used to indicate to change the virtual resource in account information of a user, and the change condition of the virtual resource corresponds to the playback scene of the first playback content.

According to one or more embodiments of the present disclosure, the change condition of the virtual resource comprises a target playback duration of the first playback content.

According to one or more embodiments of the present disclosure, a timer is displayed on a playback page corresponding to the playback scene, the timer is used to count a playback time of the first playback content, and a maximum counting duration of the timer is the target playback duration.

According to one or more embodiments of the present disclosure, the timing mode of the timer comprises accumulative timing and reset timing, and the timing mode of the timer corresponds to the playback scene of the first playback content.

According to one or more embodiments of the present disclosure, the timer for the accumulating timing suspends counting upon a switch from the first playback content to a second playback content, and upon a switch from the second playback content back to the first playback content, the timer resumes counting from a time when the counting is suspended.

According to one or more embodiments of the present disclosure, the timer for the resetting timing resets upon a switch from the first playback content to a second playback content, and upon a switch from the second playback content back to the first playback content, the timer restarts from zero.

According to one or more embodiments of the present disclosure, second indication information is further displayed on a playback page corresponding to the playback scene, and the second indication information is used to indicate a change parameter of the virtual resource.

According to one or more embodiments of the present disclosure, the sending module 402 is further configured to send a first request to the first server, where the first request is used to request to obtain the first playback content played in the playback scene.

The first request includes an identifier of the playback scene and an identifier of the user.

According to one or more embodiments of the present disclosure, the apparatus for playback control 400 further comprises:
a receiving module 403 configured to receive first feedback sent by the first server, where the first feedback includes the first playback content to be played, the changing condition of the virtual resource and a change parameter of the virtual resource; and
a processing module 404 configured to play the first playback content in the playback scene, based on the first feedback.

According to one or more embodiments of the present disclosure, the first playback content includes a video and/or a text.

It should be noted that the apparatus for playback control provided the embodiment shown in FIG. 5 may be configured to perform the method provided by any embodiment on the client side, and the specific implementation and technical effect are similar, which are not elaborated herein.

FIG. 6 is a schematic structural diagram of another apparatus for playback control provided by embodiments of the present disclosure. The apparatus for playback control is configured to perform the method for playback control on the first server side. As shown in FIG. 6, the apparatus for playback control 500 provided by embodiments of the present disclosure includes:
a receiving module 501 configured to receive a first request sent by a client, wherein the first request is used to request to obtain a first playback content played in a playback scene and the first request includes an identifier of the playback scene;
a processing module 502 configured to determine, based on the identifier of the playback scene, a change condition of a virtual resource in account information of a user corresponding to the first playback content to be played; and
a sending module 503 configured to send first feedback to the client, wherein the first feedback includes the first playback content and the change condition of the virtual resource.

According to one or more embodiments of the present disclosure, the first request further comprises an identification of the user.

The sending module 503 is further configured to send a second request to a second server, the second request being used to request to match the first play content corresponding to the user and the second request including an identifier of the user.

The receiving module 501 is further configured to receive second feedback sent by the second server, the second feedback including the first playback content and resource value information of the first playback content, and the resource value information of the first playback content being used to determine a change parameter of the virtual resource.

According to one or more embodiments of the present disclosure, the first feedback further includes the change parameter of the virtual resource.

The sending module 503 is further configured to send the resource value information of the first playback content to a third server.

The receiving module 501 is further configured to receive the change parameter of the virtual resource sent by the third server.

It should be noted that the apparatus for playback control provided the embodiment shown in FIG. 6 may be configured to perform the method provided by any embodiment on the first server side, and the specific implementation and technical effect are similar, which are not elaborated herein.

FIG. 7 is a schematic structural diagram of yet another apparatus for playback control provided by embodiments of the present disclosure. The apparatus for playback control is configured to perform the method for playback control on the second server side. As shown in FIG. 7, the apparatus for playback control 600 provided by embodiments of the present disclosure includes:
a receiving module 601 configured to receive a second request sent by a first server, wherein the second request is used to request to match a first playback content corresponding to a user and the second request includes an identifier of the user;
a processing module 602 configured to determine, based on the identifier of the user, the first playback content corresponding to the user; and
a sending module 603 configured to send second feedback to the first server, wherein the second feedback information includes the first playback content.

According to one or more embodiments of the present disclosure, the second feedback further includes resource value information of the first playback content.

The processing module 602 is further configured to determine the resource value information of the first playback content based on a predicted click rate of the user and a predicted playback gain of the first playback content.

It should be noted that the apparatus for playback control provided the embodiment shown in FIG. 7 may be configured to perform the method provided by any embodiment on the second server side, and the specific implementation and technical effect are similar, which are not elaborated herein.

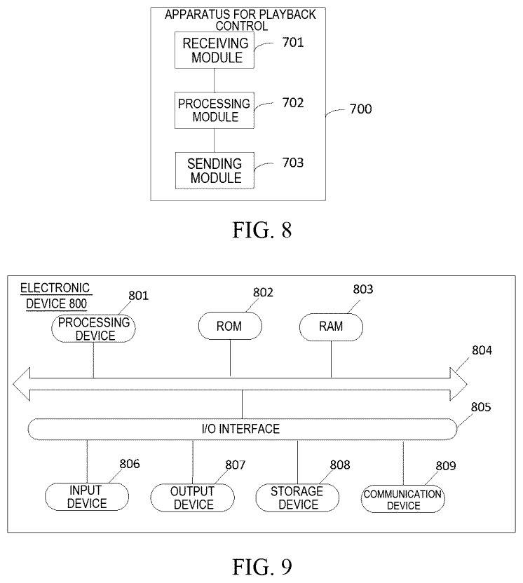

FIG. 8 is a schematic structural diagram of yet another apparatus for playback control provided by embodiments of the present disclosure. The apparatus for playback control is configured to perform the method for playback control on the third server side. As shown in FIG. 8, the apparatus for playback control 700 provided by embodiments of the present disclosure includes:
a receiving module 701 configured to receive resource value information of a first playback content sent by a first server;
a processing module 702 configured to determine a change parameter of a virtual resource in account information of a user based on the resource value information of the first playback content; and
a sending module 703 configured to send the change parameter of the virtual resource to the first server.

According to one or more embodiments of the present disclosure, the processing module 702 is further configured to determine the change parameter of the virtual resource based on the resource value information of the first playback content and a predetermined playback conversion parameter.

It should be noted that the apparatus for playback control provided the embodiment shown in FIG. 8 may be configured to perform the method provided by any embodiment on the third server side, and the specific implementation and technical effect are similar, which are not elaborated herein.

FIG. 9 is a schematic structural diagram of an electronic device provided by embodiments of the present disclosure. Referring to FIG. 9, which illustrates a schematic structural diagram of an electronic device 800 adapted to implements embodiments of the present disclosure. The terminal devices according to the embodiments of the present disclosure may include, but are not limited to, a mobile terminal such as a mobile phone, a laptop computer, a digital broadcast receiver, a Personal Digital Assistant (PDA), a tablet computer or Portable Android Device (PAD), a Portable Multimedia Player (PMP), or a vehicle-mounted terminal (e.g., a vehicle-mounted navigation terminal), or a fixed terminal such as a digital TV, a desktop computer, etc. The electronic device illustrated in FIG. 9 is only an example and should not be construed as limiting the function and scope of use of the embodiments of the present disclosure.

As illustrated in FIG. 9, the electronic device 800 may include a processing device (such as a central processing unit, a graphics processing unit, etc.) 801, which may perform various appropriate actions and processes in accordance with programs stored in a read only memory (ROM) 802 or loaded from a storage device 808 into a random access memory (RAM) 803. In the RAM 803, various programs and data required for the operation of the electronic device 800 may also be stored. The processor 801, the ROM 802, and the RAM 803 are connected to each other through a bus 804. An input/output (I/O) interface 805 is also connected to the bus 804. The memory is configured to store programs to execute the methods of the various method embodiments above and the processor is configured to execute the programs stored in the memory, so as to implement functions of the above embodiments of the present disclosure and/or other desired functions.

Generally, the following devices may be connected to the I/O interface 805: an input device 806 including, for example, a touch screen, a touch pad, a keyboard, a mouse, a camera, a microphone, an accelerometer, a gyroscope, etc.; an output device 807 including, for example, a liquid crystal display (LCD), a speaker, a vibrator, and the like; a storage device 808 including, for example, magnetic tape, hard disk, etc.; and a communication device 809. The communication device 809 may allow the electronic device 800 to perform wireless or wired communication with other devices for data exchange. Although FIG. 9 illustrates the electronic device 800 having various devices, it should be understood that it is not necessary to implement or provide all the illustrated devices. Alternatively, more or fewer devices may be implemented or provided.

In particular, according to an embodiment of the present disclosure, the processes described above with reference to the flowcharts may be implemented as computer software programs. For example, an embodiment of the present application includes a computer program product, which includes a computer program carried on a non-transient computer-readable medium. The computer program includes program codes for implementing the method illustrated in any of the flowcharts. In these embodiments, the computer program may be downloaded and installed from a network through the communication device 809, or installed from the storage device 808, or installed from the ROM 802. The computer program, when executed by the processing device 801, implements the above-mentioned functions defined in the method according to the embodiments of the present disclosure.

It is to be noted that the above computer-readable medium in the present disclosure may be a computer-readable signal medium or a computer-readable storage medium or any combination thereof. The computer-readable storage medium may be, but not limited to, for example, an electrical, magnetic, optical, electromagnetic, infrared, or semiconductor system, apparatus, or device, or any combination thereof. More specific examples of the computer-readable storage medium may include, but not limited to: an electrical connection having one or more wires, a portable computer disk, a hard disk, a random access memory (RAM), a read only memory (ROM), an erasable programmable read only memory (EPROM) or a flash memory, an optical fiber, a compact disc read-only memory (CD-ROM), an optical storage device, a magnetic storage device, or any suitable combination thereof. In the present application, the computer-readable storage medium may be any tangible medium including or storing programs, which may be used by or used with an instruction execution system, apparatus, or device. However, in the present application, the computer-readable signal medium may include a data signal propagated in a baseband or as a part of a carrier that carries computer-readable program codes. Such propagated data signal may be in various forms, including but not limited to an electromagnetic signal, an optical signal, or any suitable combination thereof. The computer-readable signal medium may be any computer-readable medium other than the computer-readable storage medium, which may transmit, propagate, or transfer programs used by or used with an instruction execution system, apparatus or device. The program codes contained on the computer-readable medium may be transmitted via any appropriate medium, including but not limited to electric cable, optical cable, Radio Frequency (RF), or any suitable combination thereof.

The above-mentioned computer-readable medium may be included in the above-mentioned electronic device; it may also exist independently without being assembled into the electronic device.

The computer readable medium carries one or more programs. When the one or more programs are executed by the electronic device, the electronic device display a first photographing interface in response to a first instruction triggered by a user, wherein the first photographing interface comprises a plurality of target photographing modes; in response to a triggering operation of a user on a first photographing interface, acquiring a first virtual resource, and displaying an icon corresponding to the first virtual resource on the first photographing interface; wherein the plurality of target shooting modes include at least one variable shooting mode, and the variable shooting mode is configured to change with time.

The computer program codes for implementing the operations of the present application may be written in one or more programming languages or any combination thereof. The programming languages may include object-oriented programming languages, such as Java, Smalltalk, or C++, as well as conventional procedure-oriented programming languages, such as “C” language or similar programming languages. The program codes may be executed completely on a user computer, partly on the user computer, as a standalone software package, partly on the user computer and partly on a remote computer, or completely on the remote computer or server. In a case where the remote computer is involved, the remote computer may be connected to the user computer through any types of networks, including a Local Area Network (LAN) or a Wide Area Network (WAN), or to an external computer (e.g., over the Internet by using an Internet service provider).

In some embodiments, the client and the server may perform communication using any currently known or future developed network protocol such as HTTP (HyperText Transfer Protocol) and may be interconnected with any form or medium of digital data communication (for example, a communication network). The communication network embodiments include local area networks (“LANs”), wide area networks (“WANs”), internet, end-to-end networks (for example, ad hoc end-to-end networks), and any networks currently known or developed in the future.

The flowchart and block diagram in the attached figure illustrate the possible architecture, functions, and operations of systems, methods, and computer program products according to various embodiments of the present disclosure. At this point, each box in a flowchart or block diagram can represent a module, program segment, or part of code that contains one or more executable instructions for implementing specified logical functions. It should also be noted that in some alternative implementations, the functions indicated in the boxes can also occur in a different order than those indicated in the accompanying drawings. For example, two consecutive boxes can actually be executed in parallel, and sometimes they can also be executed in the opposite order, depending on the function involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions.

The modules described in the embodiments of the present disclosure can be implemented through software or hardware. The name of the module does not constitute a qualification for the module itself in a certain situation.

The functions described above in this specification can be at least partially executed by one or more hardware logic components. For example, non-limiting examples of hardware logic components that can be used include: Field Programmable Gate Arrays (FPGAs), Application Specific Integrated Circuits (ASICs), Application Specific Standard Products (ASSPs), On Chip Systems (SOC), Complex Programmable Logic Devices (CPLDs), and so on.

In the context of this disclosure, a computer readable medium can be tangible media that can contain or store programs for use by or in combination with instruction execution systems, devices, or devices. A computer readable medium can be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In a first aspect, according to one or more embodiments of the present disclosure, there is provided a method for playback control, which is applied at a client and includes:
obtaining a playback duration of a first playback content in a playback scene; and
in response the playback duration satisfying a change condition of a virtual resource, sending first indication information to a first server, wherein the first indication information is used to indicate to change the virtual resource in account information of a user, and the change condition of the virtual resource corresponds to the playback scene of the first playback content.

According to one or more embodiments of the present disclosure, the change condition of the virtual resource comprises a target playback duration of the first playback content.

According to one or more embodiments of the present disclosure, a timer is displayed on a playback page corresponding to the playback scene, the timer is used to count a playback time of the first playback content, and a maximum counting duration of the timer is the target playback duration.

According to one or more embodiments of the present disclosure, the timing mode of the timer comprises accumulative timing and reset timing, and the timing mode of the timer corresponds to the playback scene of the first playback content.

According to one or more embodiments of the present disclosure, the timer for the accumulating timing suspends counting upon a switch from the first playback content to a second playback content, and upon a switch from the second playback content back to the first playback content, the timer resumes counting from a time when the counting is suspended.

According to one or more embodiments of the present disclosure, the timer for the resetting timing resets upon a switch from the first playback content to a second playback content, and upon a switch from the second playback content back to the first playback content, the timer restarts from zero.

According to one or more embodiments of the present disclosure, second indication information is further displayed on a playback page corresponding to the playback scene, and the second indication information is used to indicate a change parameter of the virtual resource.

According to one or more embodiments of the present disclosure, the method further comprises before obtaining the playback duration of the first playback content in the playback scene,
sending a first request to the first server, the first request being used to request to obtain the first playback content played in the playback scene;
wherein the first request includes an identifier of the playback scene and an identifier of the user.

According to one or more embodiments of the present disclosure, the method further comprises after sending the first request to the first server,
receiving first feedback sent by the first server, the first feedback including the first playback content to be played, the changing condition of the virtual resource and a change parameter of the virtual resource; and
playing the first playback content in the playback scene, based on the first feedback.

According to one or more embodiments of the present disclosure, the first playback content comprises a video and/or a text.

In a second aspect, according to one or more embodiments of the present disclosure, there is provided a method for playback control, which is applied at a first server and includes:
receiving a first request sent by a client, wherein the first request is used to request to obtain a first playback content played in a playback scene and the first request includes an identifier of the playback scene;
determining, based on the identifier of the playback scene, a change condition of a virtual resource in account information of a user corresponding to the first playback content to be played; and
sending first feedback to the client, wherein the first feedback includes the first playback content and the change condition of the virtual resource.

According to one or more embodiments of the present disclosure, the first request further includes an identifier of the user, and the method further comprises after receiving an obtaining request sent by the client,
sending a second request to a second server, the second request being used to request to match the first play content corresponding to the user and the second request including an identifier of the user; and
receiving second feedback sent by the second server, the second feedback including the first playback content and resource value information of the first playback content, and the resource value information of the first playback content being used to determine a change parameter of the virtual resource.

According to one or more embodiments of the present disclosure, the first feedback further includes the change parameter of the virtual resource; the method further comprises after receiving the second feedback sent by the second server,
sending the resource value information of the first playback content to a third server; and
receiving the change parameter of the virtual resource sent by the third server.

In a third aspect, according to one or more embodiments of the present disclosure, there is provided a method for playback control, which is applied at a second server and includes:
receiving a second request sent by a first server, wherein the second request is used to request to match a first playback content corresponding to a user and the second request includes an identifier of the user;
determining, based on the identifier of the user, the first playback content corresponding to the user
sending second feedback to the first server, wherein the second feedback includes the first playback content.

According to one or more embodiments of the present disclosure, the second feedback further includes resource value information of the first playback content, and the method further comprises after the determining, based on the identifier of the user, the first playback content corresponding to the user,
determining the resource value information of the first playback content based on a predicted click rate of the user and a predicted playback gain of the first playback content.

In a fourth aspect, according to one or more embodiments of the present disclosure, there is provided a method for playback control, which is applied at a third server and includes:
receiving resource value information of a first playback content sent by a first server;
determining a change parameter of a virtual resource in account information of a user based on the resource value information of the first playback content; and
sending the change parameter of the virtual resource to the first server.

According to one or more embodiments of the present disclosure, determining the change parameter of the virtual resource in account information of the user based on the resource value information of the first playback content comprises:
determining the change parameter of the virtual resource based on the resource value information of the first playback content and a predetermined playback conversion parameter.

In a fifth aspect, according to one or more embodiments of the present disclosure, there is provided an apparatus for playback control, including:
an obtaining module configured to obtain a playback duration of a first playback content in a playback scene; and
a sending module configured to, in response the playback duration satisfying a change condition of a virtual resource, send first indication information to a first server, wherein the first indication information is used to indicate to change the virtual resource in account information of a user, and the change condition of the virtual resource corresponds to the playback scene of the first playback content.

According to one or more embodiments of the present disclosure, the change condition of the virtual resource comprises a target playback duration of the first playback content.

According to one or more embodiments of the present disclosure, a timer is displayed on a playback page corresponding to the playback scene, the timer is used to count a playback time of the first playback content, and a maximum counting duration of the timer is the target playback duration.

According to one or more embodiments of the present disclosure, the timing mode of the timer comprises accumulative timing and reset timing, and the timing mode of the timer corresponds to the playback scene of the first playback content.

According to one or more embodiments of the present disclosure, the timer for the accumulating timing suspends counting upon a switch from the first playback content to a second playback content, and upon a switch from the second playback content back to the first playback content, the timer resumes counting from a time when the counting is suspended.

According to one or more embodiments of the present disclosure, the timer for the resetting timing resets upon a switch from the first playback content to a second playback content, and upon a switch from the second playback content back to the first playback content, the timer restarts from zero.

According to one or more embodiments of the present disclosure, second indication information is further displayed on a playback page corresponding to the playback scene, and the second indication information is used to indicate a change parameter of the virtual resource.

According to one or more embodiments of the present disclosure, the sending module is further configured to send a first request to the first server, where the first request is used to request to obtain the first playback content played in the playback scene;
wherein the first request includes an identifier of the playback scene and an identifier of the user.

According to one or more embodiments of the present disclosure, the apparatus for playback control further comprises:
a receiving module configured to receive first feedback sent by the first server, where the first feedback includes the first playback content to be played, the changing condition of the virtual resource and a change parameter of the virtual resource; and
a processing module configured to play the first playback content in the playback scene, based on the first feedback.

According to one or more embodiments of the present disclosure, the first playback content includes a video and/or a text.

In a sixth aspect, according to one or more embodiments of the present disclosure, there is provided an apparatus for playback control, including:
a receiving module configured to receive a first request sent by a client, wherein the first request is used to request to obtain a first playback content played in a playback scene and the first request includes an identifier of the playback scene;
a processing module configured to determine, based on the identifier of the playback scene, a change condition of a virtual resource in account information of a user corresponding to the first playback content to be played; and
a sending module configured to send first feedback to the client, wherein the first feedback includes the first playback content and the change condition of the virtual resource.

According to one or more embodiments of the present disclosure, the first request further comprises an identification of the user.

The sending module is further configured to send a second request to a second server, the second request being used to request to match the first play content corresponding to the user and the second request including an identifier of the user.

The receiving module is further configured to receive second feedback sent by the second server, the second feedback including the first playback content and resource value information of the first playback content, and the resource value information of the first playback content being used to determine a change parameter of the virtual resource.

According to one or more embodiments of the present disclosure, the first feedback further includes the change parameter of the virtual resource.

The sending module is further configured to send the resource value information of the first playback content to a third server.

The receiving module is further configured to receive the change parameter of the virtual resource sent by the third server.

In a seventh aspect, according to one or more embodiments of the present disclosure, there is provided an apparatus for playback control, including:
a receiving module configured to receive a second request sent by a first server, wherein the second request is used to request to match a first playback content corresponding to a user and the second request includes an identifier of the user;
a processing module configured to determine, based on the identifier of the user, the first playback content corresponding to the user; and
a sending module configured to send second feedback to the first server, wherein the second feedback information includes the first playback content.

According to one or more embodiments of the present disclosure, the second feedback further includes resource value information of the first playback content.

The processing module is further configured to determine the resource value information of the first playback content based on a predicted click rate of the user and a predicted playback gain of the first playback content.

In an eighty aspect, according to one or more embodiments of the present disclosure, there is provided an apparatus for playback control, including:
a receiving module configured to receive resource value information of a first playback content sent by a first server;
a processing module configured to determine a change parameter of a virtual resource in account information of a user based on the resource value information of the first playback content; and
a sending module configured to send the change parameter of the virtual resource to the first server.

According to one or more embodiments of the present disclosure, the processing module is further configured to determine the change parameter of the virtual resource based on the resource value information of the first playback content and a predetermined playback conversion parameter.

In a ninth aspect, according to one or more embodiments of the present disclosure, there is provided a terminal device, including:
a processor; and a memory configured to store a computer program;
wherein the processor is configured to, by executing the computer program, implement the method for playback control of various possible designs of the above first aspect.

In a tenth aspect, according to one or more embodiments of the present disclosure, there is provided a server, including:
a processor; and a memory configured to store a computer program;
wherein the processor is configured to, by executing the computer program, implement the method for playback control of various possible designs of the above second aspect, third aspect or fourth aspect.

In an eleventh aspect, according to one or more embodiments of the present disclosure, there is provided an electronic device, comprising:
a processor; and a memory configured to store a computer program;
wherein the processor is configured to, by executing the computer program, implement the method for playback control of various possible designs of the above first aspect.

In a twelfth aspect, according to one or more embodiments of the present disclosure, there is provided an electronic device, comprising:
a processor; and a memory configured to store a computer program;
wherein the processor is configured to, by executing the computer program, implement the method for playback control of various possible designs of the above second aspect, third aspect or fourth aspect.

In a thirteenth aspect, according to one or more embodiments of the present disclosure, there is provide a computer readable storage medium. The computer readable storage has computer executed instructions stored thereon, the computer executed instructions, when executed by a processor, implement the method for playback control of various possible designs of the above first aspect, second aspect, third aspect or fourth aspect.

In a fourteenth aspect, according to one or more embodiments of the present disclosure, there is provided a computer program product, including a computer program which, when executed by a processor, implements the method for playback control of various possible designs of the above first aspect, second aspect, third aspect or fourth aspect.

In a fifteenth aspect, according to one or more embodiments of the present disclosure, there is provided a computer program, where the computer program is configured to implement the method for playback control of various possible designs of the above first aspect, second aspect, third aspect or fourth aspect.

The above description is only a preferred embodiment of this disclosure and an explanation of the technical principles used. Those skilled in the art should understand that the scope of disclosure involved in the present disclosure is not limited to technical solutions formed by specific combinations of the aforementioned technical features, but also covers other technical solutions formed by any combination of the aforementioned technical features or their equivalent features without departing from the disclosed concept. For example, a technical solution formed by replacing the above features with (but not limited to) technical features with similar functions disclosed in this disclosure.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for playback control, the method comprising:
obtaining a playback duration of a first playback content in a playback scene; and
in response the playback duration satisfying a target condition, sending first indication information to a first server, wherein the first indication information indicates to change a virtual resource in account information of a user, and the target condition corresponds to the playback scene of the first playback content.

2. The method of claim 1, wherein the target condition comprises a target playback duration of the first playback content.

3. The method of claim 2, wherein a timer is displayed on a playback page corresponding to the playback scene, the timer is configured to count a playback time of the first playback content, and a maximum counting duration of the timer is the target playback duration.

4. The method of claim 3, wherein the timing mode of the timer comprises accumulative timing and reset timing, and the timing mode of the timer corresponds to the playback scene of the first playback content.

5. The method of claim 4, wherein the timer for the accumulating timing suspends counting upon a switch from the first playback content to a second playback content, and upon a switch from the second playback content back to the first playback content, the timer resumes counting from a time when the counting is suspended.

6. The method of claim 4, wherein the timer for the resetting timing resets upon a switch from the first playback content to a second playback content, and upon a switch from the second playback content back to the first playback content, the timer restarts from zero.

7. The method of claim 1, wherein second indication information is further displayed on a playback page corresponding to the playback scene, and the second indication information is used to indicates a change parameter of the virtual resource.

8. The method of claim 1, wherein the method further comprises before obtaining the playback duration of the first playback content in the playback scene,
sending a first request to the first server, the first request being configured to request to obtain the first playback content played in the playback scene;
wherein the first request includes an identifier of the playback scene and an identifier of the user.

9. The method of claim 8, wherein the method further comprises after sending the first request to the first server,
receiving first feedback sent by the first server, the first feedback including the first playback content to be played, the target condition and a change parameter of the virtual resource; and
playing the first playback content in the playback scene, based on the first feedback.

10. The method of claim 1, wherein the first playback content comprises a video and/or a text.

11. A method for playback control, the method comprising:
receiving a first request sent by a client, wherein the first request is configured to request to obtain a first playback content played in a playback scene and the first request includes an identifier of the playback scene;
determining, based on the identifier of the playback scene, a target condition in account information of a user corresponding to the first playback content to be played; and
sending first feedback to the client, wherein the first feedback includes the first playback content and the target condition.

12. The method of claim 11, wherein the first request further includes an identifier of the user, and the method further comprises after receiving an obtaining request sent by the client,
sending a second request to a second server, the second request being configured to request to match the first play content corresponding to the user and the second request including an identifier of the user; and
receiving second feedback sent by the second server, the second feedback including the first playback content and resource value information of the first playback content, and the resource value information of the first playback content being configured to determine a change parameter of the virtual resource.

13. The method of claim 12, wherein the first feedback further includes the change parameter of the virtual resource; the method further comprises after receiving the second feedback sent by the second server,
sending the resource value information of the first playback content to a third server; and
receiving the change parameter of the virtual resource sent by the third server.

14. (canceled)

15. (canceled)

16. (canceled)

17. (canceled)

18. (canceled)

19. (canceled)

20. (canceled)

21. (canceled)

22. A terminal device, comprising:
a processor; and a memory configured to store a computer program;
wherein the processor is configured to, by executing the computer program perform operations comprising:
obtaining a playback duration of a first playback content in a playback scene; and
in response the playback duration satisfying a target condition, sending first indication information to a first server, wherein the first indication information indicates to change a virtual resource in account information of a user, and the target condition corresponds to the playback scene of the first playback content.

23. (canceled)

24. (canceled)

25. (canceled)

26. (canceled)

27. (canceled)

28. (canceled)

29. The terminal device of claim 22, wherein the target condition comprises a target playback duration of the first playback content.

30. The terminal device of claim 29, wherein a timer is displayed on a playback page corresponding to the playback scene, the timer is configured to count a playback time of the first playback content, and a maximum counting duration of the timer is the target playback duration.

31. The terminal device of claim 30, wherein the timing mode of the timer comprises accumulative timing and reset timing, and the timing mode of the timer corresponds to the playback scene of the first playback content.

32. The terminal device of claim 31, wherein the timer for the accumulating timing suspends counting upon a switch from the first playback content to a second playback content, and upon a switch from the second playback content back to the first playback content, the timer resumes counting from a time when the counting is suspended.

33. The terminal device of claim 31, wherein the timer for the resetting timing resets upon a switch from the first playback content to a second playback content, and upon a switch from the second playback content back to the first playback content, the timer restarts from zero.

34. The terminal device of claim 22, wherein second indication information is further displayed on a playback page corresponding to the playback scene, and the second indication information indicates a change parameter of the virtual resource.
